(19) United States
(12) Patent Application Publication
(10) Pub. No.: US 2026/0355724 A1
(43) Pub. Date: Nov. 12, 2026

(54) SOLID ACID-BASE CATALYST FOR PRODUCING INSULATING OIL OF TRANSFORMER, AND PREPARATION METHOD AND USE THEREOF

(71) Applicants: SHANDONG UNIVERSITY OF TECHNOLOGY, Zibo (CN); SHANDONG LUKONG ELECTRIC POWER EQUIPMENT CO., LTD, Dezhou (CN)

(72) Inventors: Shuguang ZHANG, Zibo (CN); Zongjun XIN, Dezhou (CN); Manman ZHAO, Zibo (CN); Xin XIN, Dezhou (CN); Long WANG, Zibo (CN); Yawen ZHANG, Zibo (CN); Xingyu CHEN, Zibo (CN); Hongzheng LIU, Dezhou (CN); Yong LI, Dezhou (CN); Yang YANG, Dezhou (CN)

(21) Appl. No.: 19/139,627

(22) PCT Filed: Jan. 4, 2024
(86) PCT No.: PCT/CN2024/070552

§ 371 Date: Jun. 16, 2025

(30) Foreign Application Priority Data
Jan. 28, 2023 (CN) 202310042526.5

(51) Int. Cl. B01J 27/053; B01J 37/00; B01J 37/02; B01J 37/04; B01J 37/06

(52) U.S. Cl. CPC B01J 27/053; B01J 37/009; B01J 37/0211; B01J 37/04; B01J 37/06

(57) ABSTRACT

A solid acid-base catalyst for producing an insulating oil of a transformer, and a preparation method and use thereof are provided. The preparation method includes constructing a catalyst alkaline skeleton, leaching a macroporous template in a catalyst skeleton, and loading a solid superacid active site to obtain the solid acid-base catalyst for producing the insulating oil of the transformer.

The present application claims priority to Chinese Patent Application No. 202310042526.5 filed with the China National Intellectual Property Administration (CNIPA) on Jan. 28, 2023 and entitled “PREPARATION METHOD AND USE OF SOLID ACID-BASE CATALYST FOR PRODUCING INSULATING OIL OF TRANSFORMER”, which is incorporated herein by reference in its entirety.

### TECHNICAL FIELD

The present disclosure belongs to the technical field of fine chemicals, and specifically relates to a solid acid-base catalyst for producing an insulating oil of a transformer, a preparation method and use thereof.

### BACKGROUND

Insulating oil, as a liquid medium, is widely used in various electrical equipment (such as transformers, circuit breakers, mutual inductors, and bushings), and plays a role of insulation, cooling and heat dissipation, as well as arc extinguishing, thereby ensuring the safe operation of electrical equipment. Mineral oil products have become the first choice of insulating oil and have been widely used due to their advantages such as low cost and desirable insulation and heat dissipation properties. However, as a petroleum refining product, the mineral insulating oil has high volatility, low flash point (a temperature of 170 °C to 180 °C) and ignition point, and poor fire resistance, and could cause pollution to the surrounding environment once being leaked. In view of this, scientific research and technical personnel in various countries have conducted a lot of research on alternative products, and have successively developed non-fuel products such as silicone oil, synthetic esters (such as pentaerythritol ester), a oil, R oil, polyalphaolefins, and high molecular weight hydrocarbon (HMWH) oil. However, these products are generally only used in situations where extremely high fire resistance is required due to their high synthesis costs. Therefore, mineral insulating oil has firmly occupied a dominant position in the insulating oil market for many years.

As the public's environmental awareness increases, the shortcomings of mineral insulating oil, such as poor biodegradability and easy pollution, are increasingly criticized. Therefore, a market demand for environmental-friendly and biodegradable insulating oil is becoming increasingly urgent, and products with vegetable oil and derivatives thereof as a main ingredient have become a research hotspot in the industry.

In 1999, Asea Brown Boveri Ltd. (ABB) developed a BIOTEMP vegetable insulating oil by refining and purifying high oleic sunflower oil and high oleic rapeseed oil (U.S. Pat. No. 5,949,017). In 2000, Cooper developed a vegetable insulating oil under the trade name Envirotemp FR3 by purifying natural soybean oil (U.S. Pat. No. 6,352,655). Further, L & P also developed a vegetable insulating oil Biotrans using soybean oil as a raw material, while M & I Materials developed a MideleN product. Countries such as Germany, Japan, France, Australia, and India have also conducted relevant research to evaluate the feasibility of different vegetable oil raw materials as electrical insulating media after processing.

With the gradual increase in the application scale of vegetable insulating oil, the international community has also formulated corresponding product standards for basic characteristic parameters, such as ASTM D6871 and IEEE Std C57.147. Such products are called natural ester insulating media or natural ester insulating oil.

In addition to natural ester insulating oil products, researchers have also conducted research on some plant oil derivatives. In 2002, Fuji Electric of Japan synthesized low-viscosity rapeseed fatty acid ester insulating oil using rapeseed oil and isopropyl alcohol as raw materials, showing viscosity about 0.7 times that of mineral oil. In 2009, AE Power Systems Corporation of Japan prepared a palm fatty acid ester (PFAE) insulating oil using palm oil as a raw material through two-step transesterification, and then developed an environmental-friendly transformer to match same. Amanullah et al. in Australia mixed vegetable oil and vegetable oil esterification products at a ratio of approximately 1:1, and then purified and processed a resulting mixture to obtain a mixed vegetable insulating oil product with a viscosity lower than that of natural ester insulating oil, and applied for Australian patent AU2006301929B2.

Domestically, Chongqing University, China Electric Power Research Institute, Henan Electric Power Research Institute, and Wuhan Zedian have also conducted a series of research. Li Xiaohu et al. processed genetically modified rapeseed oil through alkali refining and adsorption to obtain a product with desirable insulation properties, and then studied the aging properties of an oil-paper insulation system for the product. Li Jian et al. improved the insulation properties of camellia seed oil by refining and purifying same, and then investigated the effects of several antioxidants on an initial oxidation temperature of the camellia seed oil using pressure differential scanning calorimetry (PDSC). Zhang Zhaotao et al. modified a rapeseed oil with Fe₃O₄ nanoparticles to improve insulation properties (a breakdown voltage was increased by 20%). Sun Dagui et al. studied the physical, chemical, and electrical properties of rapeseed oil methyl ester, which showed low viscosity and high insulation performance, and had a viscosity 0.6 times that of mineral oil, a flash point not less than 170 °C, and an industrial frequency breakdown voltage of up to 64 kV.

Guangdong Zhuoyuan New Materials Technology Co., Ltd. had also conducted some research in collaboration with scientific research institutions such as Xi'an Jiaotong University, Northwest University, and Shaanxi Institute of Microbiology, and then developed a natural ester insulating oil product (CN102827675A) with soybean oil as a main raw material and a trade name of RAPO®. Chongqing University, State Grid Electric Power Research Institute (Wuhan Nanrui Corporation), and Henan Electric Power Company Electric Power Research Institute had also launched products such as RBD, VinsOil, and NP, respectively.

Due to differences in molecular structure and molecular weight, vegetable oil has the following outstanding advantages over mineral oil:
(1) The vegetable oil shows an excellent electrical insulation performance.
(2) The vegetable oil has both high flash point and ignition point. Mineral insulating oil has a closed cup flash point of about 150 °C, while vegetable oil generally has a flash point of over 280 °C. Moreover, the flame retardancy of vegetable oil far exceeds that of the mineral oil, and is not inferior to high-temperature insulating oils such as synthetic a oil and silicone oil.
(3) The vegetable oil is highly biodegradable and environmental-friendly.
(4) The raw materials of vegetable oil are widely available and renewable.

However, the vegetable oil also has prominent disadvantages:
(1) The vegetable oil has poor low-temperature performance, great viscosity, and high freezing point, especially when being used in cold climate conditions.
(2) The presence of unsaturated bonds in the molecules makes an oxidative stability of the vegetable oil significantly weaker than that of the mineral oil.

Therefore, reducing viscosity, lowering pour point, and improving oxidation stability have become the core issues that need to be solved in the research of base oil for vegetable insulating oil. However, it is difficult to achieve the above processes only through physical refining and additive addition (such as viscosity reducer and pour point depressant). It is also difficult to achieve both the goals of improving low-temperature performance and improving oxidation stability to a certain extent. Many researchers prepare base oils by transesterification with short-chain alcohols (including methanol and ethanol). Although the physical, chemical, and electrical properties of a resulting product are excellent, the flash point and ignition point are greatly reduced (less than 200 °C). Moreover, the high viscosity and pour point have not been completely avoided, such that it is necessary to develop a novel refining process for the base oil.

So far, there are no products on the market that use vegetable oil derivatives as the base oil of insulating oil.

In summary, the research on vegetable insulating oil at home and abroad mainly focuses on raw material systems such as soybean oil, rapeseed oil, palm oil, and camellia oil, while there is little research on the cottonseed oil system, which has abundant raw materials, high quality, and low cost.

Catalysts commonly used in transesterification mainly include three categories: acid (homogeneous or solid acid), base (homogeneous or solid base), and enzyme catalysts. The enzyme catalyst has low requirements for raw oil, mild reaction conditions, no side reactions, no wastewater generation, and easy product separation, but a high cost limits its application. The acid catalyst is insensitive to the moisture and acid value in the raw oil, but there are high reaction temperature and low reaction rate. The base catalyst has high catalytic efficiency and mild reaction conditions, but is sensitive to the moisture and acid value in the raw oil, resulting in difficulty during separation. In addition, although homogeneous (liquid) acid and base catalysts have better catalytic performance, they also obviously make auxiliary processes such as product purification and separation complicated and cumbersome, and can produce a large amount of salt-containing wastewater. The catalysts at this time cannot be recycled multiple times, which not only increases production cost, but also creates a heavy burden on environmental management, thus seriously affecting the profit margin of the product and exhibiting environmental-unfriendly. In contrast, heterogeneous solid acid and base catalysts could overcome the above-mentioned defects and exhibit easy separation and reusability without generating any wastewater or waste, thereby the process is environmental-friendly.

As is well-known, the moisture, acid value, impurity content and other indicators of the domestically produced fourth-grade cottonseed oil are relatively high. The use of a single base catalyst cannot overcome the bottlenecks of active site poisoning, saponification side reactions, and difficulty in separating the water and oil phases that occur simultaneously in the transesterification. In order to solve these problems, an acid-catalyzed esterification pretreatment process could be introduced before the transesterification, that is, the free fatty acids in raw materials are converted into fatty acid esters.

So far, the preparation of a bifunctional catalyst has been mostly achieved by physically mixing two monofunctional catalysts. However, the solid acid-base bifunctional integrated catalyst synthesized by the above strategy may have a greatly weakened catalytic activity due to the random distribution and contact neutralization effect (macrochemical incompatibility) between the acid and base active sites. Moreover, it is impossible to control a time sequence of the interactions between the reactants and a single active site. This is particularly critical for systems with impurity side reactions or competitive reactions, since components (or impurity) in the reaction system might interfere with the reactions of other components to reduce the yield of the target product.

In recent years, researchers have utilized the principle of spatial segregation to prepare macroscopically chemically incompatible catalytic sites, acid and base, in situ into a single material through a sol-gel wet chemistry method. For example, a core-shell nanostructured catalyst could achieve control of the reaction sequence. However, there are two drawbacks: (1) the catalytic activity needs to be improved, which is restricted by factors such as low active site loading capacity and poor accessibility of active sites; (2) the catalyst has an easily collapsed structure, poor stability, and limited number of cycles.

Chinese patent CN104437632A has disclosed a macroporous acid-base bifunctional organic solid catalyst, and a preparation method and use thereof. In the preparation method, p-styrene sulfonic acid (SS), a water-soluble polymerizable alkaline monomer, an initiator, a crosslinker, and an emulsifier are added into deionized water to obtain an aqueous phase and then stirred to mix evenly. Paraffin is used as an oil phase and added dropwise into the aqueous phase under constant stirring to prepare a stable high internal phase emulsion. The emulsion is heated to a temperature of 60 °C to 85 °C, and conducting polymerization for 15 hours (h) to 26 hours, and a resulting reaction product is subjected to Soxhlet extraction with acetone and vacuum drying to obtain a polymer. The polymer is added into a dilute acid solution, a resulting mixture is subjected to stirring, filtering, washing with deionized water, and vacuum-drying to obtain the macroporous acid-base bifunctional organic solid catalyst, which is further used in the chemical reaction of producing 5-hydroxymethylfurfural from cellulose. The organic polymer-based macroporous solid acid-base catalyst prepared in the patent has the following main defects: (1) acidic sites are formed by acid impregnation, such that there is a weak binding force between the acidic sites and the catalyst substrate material, and they are easily detached and lose activity during use; (2) the two active sites of acid and base are mixed in space, and can easily cause catalyst poisoning and inactivation.

Chinese patent CN105642345A has disclosed a preparation method of a hydrophobic hierarchical solid acid-base bifunctional catalyst. A stable Pickering high internal phase emulsion is prepared by using alkaline functionalized hydrophobic nanoparticles (S—NH2) and Sorbitan oleate (Span 80) as an emulsifier. An aqueous phase includes deionized water and potassium sulfate, while an oil phase includes divinylbenzene (DVB), 1-hexene, trimethylolpropane trimethacrylate (TMPTMA), and 2,2′-azobisisobutyronitrile (AIBN). The hydrophobic hierarchical solid acid-base bifunctional catalyst (PAPCs) is finally obtained by emulsion polymerization and sulfonation, and then used in the chemical reaction of preparing 5-hydroxymethylfurfural from cellulose. The main problems with this patent are as follows: (1) the catalyst is an organic polymer material that cannot withstand high-temperature heat treatment, and there is a limited catalyst regeneration effect; (2) acidic sites formed by acid impregnation and drying cannot be subjected to the high-temperature heat treatment, such that there is a weak binding force between the acidic sites and the catalyst substrate material, and they are easily detached and lose activity during use.

Chinese patent CN102682869A has disclosed a vegetable insulating oil and a preparation method thereof. The vegetable insulating oil is prepared using a refined vegetable oil as a raw material, which undergoes transesterification with low molecular alcohol. After the reaction is completed, an obtained reaction product is subjected to refined washing, vacuum distillation to remove water and alcohol, decolorization, deacidification, filtration, and deep water removal in sequence, and finally an antioxidant and a pour point depressant are added. The vegetable insulating oil prepared by this patent has the following main defects: (1) the transesterification is mainly conducted with small molecular alcohols, such that the insulating oil obtained has both low flash point and ignition point and common fire resistance; (2) the prepared insulating oil has a high solidification point (pour point) and could not be used in working conditions with strict requirements on low-temperature performance, such as the Northeast, Northwest, and Qinghai-Tibet Plateau.

Chinese patent CN102827675A has disclosed a method for preparing an environmental-friendly insulating oil using a vegetable oil or recycled oil as a raw material. The method includes the following steps: subjecting a vegetable oil or recycled oil with an acid value of (4-100) mgKOH·g⁻¹ to low-temperature dewaxing to obtain a pour point-depressed oil; subjecting the pour point-depressed oil to catalytic esterification until the acid value is not more than 10 mgKOH·g⁻¹, and then alkaline neutralization to obtain an deacidified oil; subjecting the deacidified oil to mixed decolorization to obtain a decolorized oil; subjecting the decolorized oil to vacuum distillation, and then water vapor vacuum deodorization by heating to a temperature of 200 °C to 220 °C to obtain a deodorized oil; subjecting the deodorized oil to another vacuum distillation to obtain a dehydrated oil; and fully mixing the dehydrated oil with 0.1 wt % to 0.5 wt % of an antioxidant to obtain the environmental-friendly insulating oil. The main problem of this patent is that the transesterification is conducted with a homogeneous liquid base catalyst, which cannot be reused; and a large amount of waste brine and solid waste is generated during the product separation and purification, which is environmental-unfriendly.

### SUMMARY

The present disclosure is to provide a solid acid-base catalyst for producing an insulating oil of a transformer and a preparation method thereof. The solid acid-base catalyst has high activity and slow performance decay, and could realize a one-pot cascade catalytic conversion process to obtain high value-added fine chemical products. The preparation method saves multiple steps of intermediate separation and purification, greatly simplifies the process, greatly improves atomic efficiency and energy efficiency, and greatly reduces equipment investment and operating costs. Moreover, the entire production has no wastewater and solid waste discharge, and is of excellent economic benefits and extensive social benefits. The present disclosure further provides use of the solid acid-base catalyst for producing an insulating oil of a transformer, where the solid acid-base catalyst is used to produce the insulating oil of the transformer by transesterification of a vegetable oil.

The present disclosure provides a method for preparing a solid acid-base catalyst for producing an insulating oil of a transformer, including the following steps:

### (1) Constructing a Catalyst Alkaline Skeleton

a, Preparing a Catalyst Alkaline Substrate
adding an amphiphilic block copolymer into deionized water, subjecting the amphiphilic block copolymer to acidification by adding an acid, mixing evenly, and subjecting a resulting mixture to standing to allow self-assembly to form a lyotropic liquid crystal micelle, and then adding a metal nitrate and a silicate into the lyotropic liquid crystal micelle and stirring to obtain a catalyst alkaline substrate solution A;
b, preparing a monodisperse polymer colloid nanosphere used as a macroporous hard template
adding an initiator dropwise into a polymer monomer and ultrapure water under inert gas protection and stirring, and conducting a reaction to obtain a white polymer colloid nanospheres, and subjecting the white polymer colloid nanospheres to washing and then vacuum drying to obtain nanospheres B; alternatively,
adding an initiator dropwise into polymer monomer, a coupling monomer, an emulsifier, and ultrapure water under inert gas protection and stirring, and conducting a reaction to obtain white polymer colloid nanospheres, and then subjecting the white polymer colloid nanospheres to washing and then vacuum drying to obtain nanospheres B; and
c, blending and gelling the catalyst alkaline substrate and the macroporous template,
mixing the catalyst alkaline substrate solution A and the nanospheres B and subjecting a resulting system to homogenization by stirring, and then aging to obtain a catalyst alkaline skeleton C; and

### (2) Leaching the Macroporous Template in a Catalyst Skeleton and Loading a Solid Superacid Active Site

a, leaching the macroporous template in the catalyst skeleton
adding the catalyst alkaline skeleton C into a good solvent of a polymer hard template, subjecting an obtained mixture to stirring, leaching, and vacuum filtration in sequence, and then washing an obtained filter cake to obtain a catalyst precursor D in which a hard template is removed; and
b, loading an acidic active site in a catalyst
adding the catalyst precursor D into an organic solvent, adding an organic metal compound under inert gas protection and stirring, conducting a reaction, and subjecting a resulting reaction product to vacuum filtration to obtain a filter cake, and then drying the filter cake to obtain a dry filter cake;
subjecting the dry filter cake to hydrolysis to obtain a hydrolysis filter cake, and then subjecting the hydrolysis filter cake to vacuum drying to obtain a powder E; and
impregnating the powder E with an alcohol solution of ammonium sulfate under stirring at room temperature, subjecting an obtained system to vacuum filtration to obtain a filter cake, and then subjecting the filter cake to vacuum drying and calcination in sequence to remove a polyether in the filter cake to obtain the solid acid-base catalyst for producing the insulating oil of the transformer; where
the amphiphilic block copolymer in a of step (1) is a polyether having a structure of poly(ethylene oxide) (PEO)-poly(propylene oxide) (PPO)-PEO;
the amphiphilic block copolymer, the metal nitrate, and the silicate in a of step (1) is in a range of 1: (5-8):(60-110);
the catalyst alkaline substrate solution A to the nanospheres B in c of step (1) is in a range of 3:2 to 4:2;
in b of step (2), the organic metal compound is one or two selected from the group consisting of an organic titanium compound and an organic zirconium compound, and a mass ratio of the catalyst precursor D to the organic metal compound is in a range of 1:1 to 4:1; and
the reaction is conducted at a temperature of 50 °C to 80 °C for 24 hours to 48 hours, the impregnating is conducted for 2 hours to 6 hours, the calcination is conducted at a temperature of 400 °C to 700 °C for 4 hours to 6 hours, and the alcohol solution of the ammonium sulfate has a concentration of 0.1 mol/L to 0.4 mol/L.

The amphiphilic block copolymer in a of step (1) includes at least P123, and may also include one or more selected from the group consisting of L123, P103, L62, F127, and F68. In some embodiments, the L123 is L123 produced by BASF.

The acid in a of step (1) is selected from the group consisting of an inorganic acid and an organic acid, and the acidification is conducted to a pH value of 0 to 3.

The mixing in a of step (1) is conducted at a temperature of room temperature to 60 °C.
the deionized water to the amphiphilic block copolymer in a of step (1) is in a range of 3:2 to 3:4.5.

The silicate in a of step (1) is one or more selected from the group consisting of tetramethyl orthosilicate (TMOS), tetraethyl orthosilicate (TEOS), tetrapropyl orthosilicate (TPOS), and tetrabutyl orthosilicate (TBOS).

The stirring in a of step (1) is conducted at a speed of 1,000 rpm to 2,000 rpm for 15 minutes to 30 minutes.
amphiphilic block copolymer, the metal nitrate, and the silicate in a of step (1) is in a range of 1: (5-8):(60-110).

The polymer monomer in b of step (1) is one or more selected from the group consisting of styrene, α-methylstyrene, p-methylstyrene, vinyltoluene, p-isobutylstyrene, and p-tert-butylstyrene.

The coupling monomer in b of step (1) is selected from the group consisting of maleic anhydride and acrylate, and an amount of the coupling monomer is 1.5% to 6% of a total mass of the polymer monomer.

The emulsifier in b of step (1) is selected from the group consisting of alkylphenol polyoxyethylene ether OP-10 and sodium dodecyl sulfate, and an amount of the emulsifier is 0.5% to 2% of the total mass of the polymer monomer.

The initiator in b of step (1) is selected from the group consisting of a single initiator and a composite initiator; the single initiator is selected from the group consisting of potassium persulfate, ammonium persulfate, and hydrogen peroxide, the composite initiator is a redox initiation system, an oxidant in the redox initiation system comprises one selected from the group consisting of the potassium persulfate, the ammonium persulfate, and the hydrogen peroxide, and a reductant in the redox initiation system is one or more selected from the group consisting of sodium sulfite, sodium bisulfite, sodium hyposulfite, and L-ascorbic acid; and an amount of the initiator is 0.1% to 7% of the total mass of the polymer monomer.

The polymer monomer and the ultrapure water in b of step (1) is in a range of 1:6 to 1:10.

The reaction in b of step (1) is conducted at a temperature of 75 °C to 85 °C.

The initiator in b of step (1) is added dropwise for 30 minutes to 120 minutes.

The washing in b of step (1) is conducted 3 to 6 times.

The vacuum drying in b of step (1) is conducted at a temperature of 60 °C to 120 °C.

The stirring in c of step (1) is conducted for 15 minutes to 30 minutes.

The aging in c of step (1) is conducted for 24 hours to 72 hours.

The good solvent in a of step (2) is selected from the group consisting of toluene, xylene, N,N-dimethylformamide (DMF), tetrahydrofuran (THF), acetone, dichloromethane (DCM), and chloroform.

The leaching in a of step (2) is conducted at a temperature of −5 °C to 0 °C for 20 seconds to 40 seconds.

The washing in a of step (2) is conducted 2 to 3 times using a cold good solvent.
catalyst alkaline skeleton C to the good solvent in a of step (2) is in a range of 1:6.5 to 1:9).

The stirring in a of step (2) is conducted at a speed of 800 rpm to 1,200 rpm.

The organic solvent in b of step (2) is selected from the group consisting of cyclohexane, hexane, carbon tetrachloride, propanol, isopropanol, tetrahydrofuran (THF), ethyl acetate, chloroform, methyl ethyl ketone, and acetone.

In b of step (2), the organic titanium compound is selected from the group consisting of tetraethyl titanate, tetraisopropyl titanate, tetrapropyl titanate, and tetrabutyl titanate; the organic zirconium compound is selected from the group consisting of tetraethyl zirconate, tetrapropyl zirconate, tetraisopropyl zirconate, and tetrabutyl zirconate; the organic hafnium compound is selected from the group consisting of tetraethyl hafnate, tetrapropyl hafnate, tetraisopropyl hafnate, and tetrabutyl hafnate; the organic iron compound is selected from the group consisting of iron ethoxide, iron n-propoxide, iron isopropoxide and iron n-butoxide; the organic tin compound is selected from the group consisting of tin ethoxide, tin n-propoxide, tin isopropoxide and tin n-butoxide.

A mass ratio of the catalyst precursor D to the organic solvent in b of step (2) is in a range of 1:(14-30).

The stirring in b of step (2) is conducted at a speed of 800 rpm to 1,200 rpm.

In the present disclosure, a catalyst prepared by the preparation method of a solid acid-base catalyst for producing an insulating oil of a transformer is used for producing the insulating oil of the transformer by transesterification of a vegetable oil.

The vegetable oil is a cottonseed oil.

In the present disclosure, the preparation method of a solid acid-base catalyst for producing an insulating oil of a transformer specifically includes the following specifically steps: (1) constructing a catalyst alkaline skeleton
a, preparing a catalyst alkaline substrate

A quantitative amount of an amphiphilic block copolymer is added into deionized water, and then subjected to acidification by adding an acid thereto. A resulting solution is placed in a variable-speed vortex mixer and then mixed evenly at a certain temperature. A resulting mixture is taken out and subjected to standing to self-assemble into a lyotropic liquid crystal micelle using the amphiphilic block copolymer as a soft template. A metal nitrate and a silicate are then added thereto in a quantitative amount and then stirred to form a catalyst alkaline substrate solution A for later use. The silicate is hydrolyzed under the action of the soft template of the surfactant of the amphiphilic block copolymer to form an SBA-15-type mesoporous silica structure.

Before oscillating and mixing, an acidity of the resulting solution is controlled within a medium-strong acid range of pH=0-3. In some embodiments, the acidity of the resulting solution is controlled within a medium-strong acid range of pH=1.5-2.5. The acidity could be adjusted by using either the inorganic acid or the organic acid, such as hydrochloric acid, sulfuric acid, nitric acid, formic acid, acetic acid, and propionic acid.

The oscillating and mixing is controlled at a temperature of room temperature to 60 °C. In some embodiments, the oscillating and mixing is controlled at a temperature of 45 °C to 50 °C.

The metal nitrate is selected from the group consisting of an alkaline earth metal nitrate, a transition metal nitrate, and a rare earth metal nitrate, such as magnesium nitrate, calcium nitrate, copper nitrate, nickel nitrate, manganese nitrate, lanthanum nitrate, cerium nitrate, and samarium nitrate.

The silicate is one or more selected from the group consisting of TMOS, TEOS, TPOS, and TBOS.

After adding the metal nitrate and silicate, the stirring is conducted at a speed of 1,000 rpm to 2,000 rpm. In some embodiments, the stirring is conducted at 1,500 rpm. In some embodiments, the stirring is conducted for 15 min to 30 min. In some embodiments, the stirring is conducted for 20 min to 25 min.
b, preparing a monodisperse polymer colloid nanosphere used as a macroporous hard template

When preparing a homopolymer nanosphere, a process includes:

Firstly, a polymerization inhibitor in the polymer monomer is removed by conventional methods. A purified monomer is added into ultrapure water. And an initiator is added dropwise at a certain temperature under the inert gas protection and stirring into a resulting solution. After the dropwise addition is completed, the stirring is continued for 24 h to 48 h until white polymer colloid nanospheres are generated. The white polymer colloid nanospheres are separated by a high-speed refrigerated centrifuge to obtain polymer nanospheres. And then the polymer nanospheres are subjected to washing and vacuum drying to obtain nanospheres B. Where the polymer monomer is selected from the group consisting of styrene, α-methylstyrene, p-methylstyrene, vinyltoluene, p-isobutylstyrene, and p-tert-butylstyrene.

When preparing a block copolymer nanosphere, a process includes:

Firstly, a polymerization inhibitor in the polymer monomer and the coupling monomer is removed by conventional methods. And then a purified monomer and an emulsifier are added into ultrapure water. And an initiator is added dropwise at a certain temperature under the inert gas protection and stirring into a resulting solution. After the dropwise addition is completed, the stirring is continued for 24 h to 48 h until white polymer colloid nanospheres are generated. The white polymer colloid nanospheres are separated by a high-speed refrigerated centrifuge to obtain polymer nanospheres. And then the polymer nanospheres are subjected to washing and vacuum drying to obtain nanospheres B. Where the polymer monomer is two selected from the group consisting of styrene, α-methylstyrene, p-methylstyrene, vinyltoluene, p-isobutylstyrene, and p-tert-butylstyrene.

The block copolymer nanospheres each have a structure of A(B-o-A)ₙB type, where A and B represent the polymer monomers, and o represents the coupling monomer; and a molar ratio the polymer monomer A to the polymer monomer B is in a range of 1:10 to 10:1.

When synthesizing the block copolymer nanospheres, maleic anhydride or acrylate could be used as the coupling monomer. In some embodiments, the acrylate is selected from the group consisting of ethyl acrylate, butyl acrylate, hydroxyethyl acrylate, and hydroxypropyl acrylate, and an amount of the acrylate is 1.5% to 6% of the total mass of the polymer monomer. In some embodiments, an amount of the acrylate is 3% to 4% of the total mass of the polymer monomer.

When synthesizing the block copolymer nanospheres, alkylphenol polyoxyethylene ether OP-10 or sodium dodecyl sulfate (SDS) could be used as the emulsifier, and an amount of the emulsifier is 0.5% to 2% of the total mass of the polymer monomer. In some embodiments, an amount of the emulsifier is 1% of the total mass of the polymer monomer.

The polymerization is conducted at a temperature of 75 °C to 85 °C.

The polymerization initiator includes a single initiator and a composite initiator, where the single initiator is selected from the group consisting of potassium persulfate, ammonium persulfate, and hydrogen peroxide; the composite initiator works by gaining and losing electrons through redox, including a redox initiation system composed of one or more selected the group consisting of persulfate (potassium, ammonium) and (sub)sulfate (sodium sulfite, sodium bisulfite, sodium hyposulfite), and L-ascorbic acid, and a redox initiation system composed of one or more selected the group consisting of hydrogen peroxide and (sub)sulfate (sodium sulfite, sodium bisulfite, sodium hyposulfite), and L-ascorbic acid.

An amount of the initiator is 0.1% to 7% of the total mass of the polymer monomer. In some embodiments, an amount of the initiator is 1% to 4% of the total mass of the polymer monomer.

A dropping speed of the initiator is controlled by a dropping time, and the total dropping time is controlled within 30 min to 120 min. In some embodiments, and the total dropping time is controlled within 60 min to 90 min. The initiator could be added dropwise in sections, and the temperature of each section is controlled in a stepwise manner, such as 75 °C, 80 °C, and 85 °C, so as to improve the uniformity and isotropy of the size in the preparation of the polymer colloid nanosphere.

Stirring speed control procedure: in the initial stage of polymerization and during the process of initiator addition, the stirring speed is controlled at 800 rpm to 1,200 rpm. In some embodiments, the stirring speed is controlled at 1,000 rpm. After the initiator addition is completed and before the appearance of the polymer colloid nanosphere appears, the stirring speed is controlled at 300 rpm to 800 rpm, in some embodiments, the stirring speed is controlled at 600 rpm. During the aging after the polymer colloid nanosphere is formed, the stirring speed is controlled at a speed of 100 rpm to 500 rpm, in some embodiments, the stirring speed is controlled at a speed of 200 rpm to 300 rpm.

A rotational speed of the centrifuge used to separate the nanospheres ranges from 8,000 rpm to 30,000 rpm. In some embodiments, the rotational speed of the centrifuge used to separate the nanospheres ranges from 15,000 rpm to 20,000 rpm.

The washing of nanospheres is conducted 3 to 6 times. In some embodiments, the washing of nanospheres is conducted 5 times.

In some embodiments, the vacuum drying is conducted at a temperature of 60 °C to 120 °C. In some embodiments, the vacuum drying is conducted at 80 °C.
c, blending and gelling the catalyst alkaline substrate with a macroporous template

The catalyst alkaline substrate solution A and the nanospheres B prepared above are quantitatively mixed. A resulting system is subjected to homogenization by stirring at a high speed for 15 min to 30 min, and a resulting material is then subjected to vacuum rotary evaporation to remove hydrolyzed small-molecular products. An obtained residue is subjected to gelling and solidification in air at room temperature, and then ageing for 24 h to 72 h to obtain a catalyst alkaline skeleton C.
(2) leaching the macroporous template in a catalyst skeleton and loading a solid superacid active site
a, leaching the macroporous template in the catalyst skeleton

The catalyst alkaline skeleton C is quantitatively added into a good solvent of the polymer hard template. A resulting mixture is subjected to stirring at a medium speed (800 rpm to 1,200 rpm), leaching at a low temperature for 30 s, and then filtering to obtain a filter cake. The filter cake is subjected to washing 2 to 3 times with a cold good solvent. The leaching is repeated 3 to 6 times to remove the polymer hard template as much as possible to obtain a catalyst precursor D in which the hard template is removed.

The good solvent is selected from the group consisting of toluene, xylene, DMF, THF, acetone, DCM, and chloroform.

The leaching is conducted at a temperature of −5 °C to 0 °C.
b, loading an acidic active site in a catalyst

The catalyst precursor D is quantitatively added into a non-polar or weakly polar organic solvent. An organic metal compound is added thereto at a temperature of 50 °C to 80 °C under stirring and inert gas protection. The stirring is continued for 24 h to 48 h. An obtained system is subjected to vacuum filtration to obtain a filter cake. And the filter cake is dried to obtain a dry filter cake.

The dry filter cake is subjected to hydrolyzing, stirring at a medium speed (800 rpm to 1,200 rpm) for 30 min to 60 min, and then vacuum filtering to obtain a hydrolysis product filter cake. Then the hydrolysis product filter cake is subjected to vacuum drying for 12 h to obtain a powder E.

The powder E is impregnated with an alcohol solution of ammonium sulfate at room temperature under medium-speed stirring (800 rpm to 1,200 rpm) for 2 h to 6 h, and then subjected to vacuum filtration to obtain a filter cake. The filter cake is subjected to vacuum drying at 120 °C for 8 h, and then calcination in a box furnace at a temperature of 400 °C to 700 °C for 4 h to 6 h to remove the polyether in the filter cake to obtain the solid acid-base catalyst for producing an insulating oil of a transformer.

The non-polar or weakly polar organic solvent is selected from the group consisting of cyclohexane, hexane, carbon tetrachloride, propanol, isopropanol, THF, ethyl acetate, chloroform, methyl ethyl ketone, and acetone.

The organic metal compound is one or more selected from the group consisting of an organic titanium compound, an organic zirconium compound, an organic hafnium compound, an organic iron compound, and an organic tin compound. The organic titanium compound is selected from the group consisting of tetraethyl titanate, tetraisopropyl titanate, tetrapropyl titanate, and tetrabutyl titanate; the organic zirconium compound is selected from the group consisting of tetraethyl zirconate, tetrapropyl zirconate, tetraisopropyl zirconate, and tetrabutyl zirconate; the organic hafnium compound is selected from the group consisting of tetraethyl hafnate, tetrapropyl hafnate, tetraisopropyl hafnate, and tetrabutyl hafnate; the organic iron compound is selected from the group consisting of iron ethoxide, iron n-propoxide, iron isopropoxide and iron n-butoxide; the organic tin compound is selected from the group consisting of tin ethoxide, tin n-propoxide, tin isopropoxide and tin n-butoxide. The organic metal compound used in the process described above is a combination of one or two of the organic metal compounds listed above, and a mixing ratio could be adjusted.

Pores with a pore size of 2 nm to 50 nm are called mesopores, and pores with a pore size of larger than 50 nm are called macropores. The catalyst particles prepared by the method according to the present disclosure contain interconnected macropores and mesopores, where the macropores exist on a surface of the catalyst in an open structure, the mesopores are distributed between the macropores. And acidic and basic active sites are highly dispersed inside the macropores and mesopores in the form of an oxide, respectively. The solid acid-base catalyst of this structure exhibits high activity and slow performance decay (excellent reusability), and could achieve cascade catalytic conversion of acid and base through a one-pot process to obtain high value-added fine chemical products. The method according to the present disclosure eliminates the need for multiple intermediate separation and purification processes, has simple process, high atomic efficiency and energy efficiency, and is environmental-friendly, thereby greatly saving equipment investment and operating costs. In the process of preparing an insulating oil of a transformer by one-pot transesterification using cottonseed oil as a raw material, the catalyst could effectively prevent the catalyst poisoning and deactivation caused by excessively high acid value of raw materials (high fatty acid content), thus reducing the restriction requirements on raw material acid value. Moreover, the prepared insulating oil of a transformer shows excellent performance indicators.

A pore formation mechanism of the present disclosure is as follows:
As is well-known, amphiphilic block copolymers such as P123 are polymer compounds that link hydrophilic PEO segments and hydrophobic PPO segments together with covalent bonds, and exhibit excellent nonionic surface activity. Under certain ratios, pH values and other conditions, the hydrophilic segments and hydrophobic segments in the amphiphilic block copolymer molecules could thermodynamically spontaneously form a large number of H1-type micelle structures. These large numbers of micelles are evenly dispersed in the solution, and the metal nitrate aqueous solution is wrapped inside the micelles by the hydrophilic segments, and the silicate is isolated between the micelles by the hydrophobic segments. The amphiphilic block copolymer molecules act as the soft template, the silicate is hydrolyzed to form SBA-15-type mesoporous silica-oxygen structures, and the polymer micelles of the metal nitrate are sealed in each mesopore. After the last step of calcination, the soft template amphiphilic block copolymer molecules are removed, and the metal nitrate is decomposed into metal oxides. Therefore, the catalyst alkaline substrate only has SBA-15-type mesoporous SiO₂ channels and the metal oxides contained inside. Since the pore size of mesopores is extremely small (about 4 nm, seeing Table 1 and FIG. 3), the metal oxides exist in the mesoporous material in the form of a highly dispersed amorphous non-crystalline state, which could be clearly seen from the wide-angle X-ray diffraction (XRD) pattern in FIG. 2.

After the catalyst alkaline substrate and the polymer nanosphere are subjected to mixing, homogenization, rotary evaporating, and then gelling and solidification, a hard contact in the shape of a spherical surface is formed between the alkaline substrate and the nanosphere. After multiple solvent leaching and dissolution to remove the polymer nanosphere, macropores are formed on the hard contact spherical surface. Moreover, these macropores are all open structures, that is, they are located on a surface of the catalyst structure framework and then in direct contact with the environment. The hydroxylated metal oxide is loaded into the macropores by hydrolysis of the metal organic compound, and a material with a macroporous structure loaded with the sulfated metal oxide (solid acid) is obtained after ammonium persulfate impregnation and calcination.

Since the alkaline substrate forms a SBA-15-type SiO₂ mesoporous channel structure after hydrolysis, the spherical shape where the macropore channels are located is directly connected to the alkaline substrate. Therefore, the macroporous and mesoporous channels in the catalyst obtained after calcination must be interconnected. This conclusion is perfectly verified by the results of the transesterification of cottonseed oil (the data of Examples 5 and 8 in Table 4). As mentioned above, the basic active sites that have a catalytic effect on the transesterification only exist in the mesopores of the catalyst, and the mesopores are all inside the material. If the macropores and mesopores are not interconnected, the cottonseed oil cannot enter the mesopores to complete the transesterification.

A catalytic mechanism of the solid acid-base catalyst in the present disclosure is as follows:

In the present disclosure, the basic active sites in the solid acid-base catalyst are dispersed in the mesopores, which are all located inside the catalyst. While the acidic active sites are dispersed in the macropores, which are all located on the surface of the catalyst, and are open structures in direct contact with the environment. Therefore, for cottonseed oil to undergo transesterification, it must enter the catalyst through the macropores, then diffuse into the mesopores along the channels between the macropores and mesopores, reach the basic active sites for transesterification, and a resulting product then diffuses out of the catalyst.

In the present disclosure, there are two main reasons why the solid acid-base catalyst exhibits high catalytic activity and slow performance decay. (1) It can be clearly seen from the wide-angle XRD pattern of FIG. 2 that the basic and acidic active sites are highly dispersed, non-crystalline, and amorphous, close to the state of a single-atom catalyst. Therefore, the availability of the active sites is close to 100%, that is, they could exert catalytic effects at the same time. (2) The acidic and basic sites of ordinary solid acid-base catalysts are generally mixed in spatial structure. If there are a large amount of free fatty acids in cottonseed oil (high acid value), when the cottonseed oil contacts the catalyst, the free fatty acids in the cottonseed oil can simultaneously and indiscriminately cover the acidic and basic active sites, thereby poisoning the basic active sites. At this time, the transesterification cannot be catalyzed, resulting in low catalytic performance and rapid performance decay. In the catalyst synthesized by the present disclosure, the acidic and basic active sites are not mixed in spatial distribution. The acidic active sites are located on the surface macropores of the catalyst, and the basic active sites are distributed in the internal mesopores of the catalyst. When the cottonseed oil with a high acid value contacts the catalyst, the acidic sites in the surface macropores are first contacted. The free fatty acids in the cottonseed oil undergo esterification under the catalytic action of the acidic sites to generate esters that are non-toxic to the basic sites. Then, the cottonseed oil passes through the channel between the macropores and the mesopores to enter the mesopores, and the raw material no longer contains free fatty acids that are toxic to the basic active sites at this time. The glycerides in the cottonseed oil begin to undergo transesterification under the catalytic action of the basic sites to generate new esters. Even after repeated use, the catalytic performance could also maintain high efficiency, such that a unique spatial structure of the catalyst brings the advantages of high catalytic activity and slow performance decay.

The present disclosure further provides use of the catalyst as described in the above technical solutions in production of an insulating oil for a transformer by transesterification of a vegetable oil.

The vegetable oil is a cottonseed oil.

The production of the insulating oil for the transformer by the transesterification of the vegetable oil is conducted through one-pot transesterification.

The one-pot transesterification is conducted at 95 °C for 6 h.

In the present disclosure, the cottonseed oil is used as a raw material to prepare a cottonseed oil derivative-based insulating oil having excellent low-temperature performance and high ignition and flash points through transesterification between the cottonseed oil and a branched alcohol.

Some embodiments of the present disclosure have the following beneficial effects:
In the present disclosure, the solid acid-base catalyst could achieve cascade catalytic conversion of acid and base through a one-pot process to obtain high value-added fine chemical products. The method according to the present disclosure eliminates the need for multiple intermediate separation and purification processes, has simple process, high atomic efficiency and energy efficiency, and is environmental-friendly, thereby greatly saving equipment investment and operating costs. In the process of preparing an insulating oil of a transformer by one-pot transesterification using cottonseed oil as a raw material, the catalyst could effectively prevent the catalyst poisoning and deactivation caused by excessively high acid value of raw materials (high fatty acid content), thus reducing the restriction requirements on raw material acid value. Moreover, the prepared insulating oil of a transformer exhibits excellent performance indicators.

### BRIEF DESCRIPTION OF THE DRAWINGS

FIG. 1 shows a small-angle X-ray Diffraction (XRD) pattern of the catalyst prepared in Example 1;

FIG. 2 shows a wide-angle XRD pattern of the catalyst prepared in Example 1;

FIG. 3 shows pore size distribution of the catalyst prepared in Example 1; and

FIG. 4 shows an N₂ physical adsorption-desorption isotherm curve of the catalyst prepared in Example 1.

### DETAILED DESCRIPTION OF THE EMBODIMENTS

The present disclosure will be further described below with reference to examples.

### Example 1

56 g of nonionic amphiphilic block copolymer (including 48 g of P123 and 8 g of P103) was added into 52 g of deionized water, and then subjected to acidification to pH=1.0 with nitric acid, and then mixing evenly at 50 °C in a variable-speed vortex mixer. A resulting mixture was taken out and subjected to standing to allow self-assembly to form a lyotropic liquid crystal micelle. 14.2 g of Ca(NO₃)₂·4H₂O and 185 mL of TEOS were added thereto, and then stirred at 1,500 rpm for 25 min to form a uniform catalyst alkaline substrate solution A1 for later use.

The polymerization inhibitor in the polymer monomer p-methylstyrene was removed by conventional process. And then 168 g of a purified polymer monomer was added into 1,370 mL of ultrapure water. Under inert gas protection, a redox initiator “ammonium persulfate+sodium bisulfite” system was added dropwise under stirring at 1,000 rpm. Amounts of the ammonium persulfate and the sodium bisulfite were 3% and 0.7% of a mass of the polymer monomer, respectively. The adding dropwise was conducted for 90 min with three stages. Each stage was conducted for 30 min, and the three stages were controlled at 75 °C, 80 °C, and 85 °C, respectively. After the adding dropwise of the initiator was completed and before the polymer colloid nanospheres appeared, the stirring speed was 600 rpm. During the aging after the white polymer colloid nanospheres were formed, the stirring speed was controlled at 200 rpm. And the stirring was performed for 12 h during the aging. Then an obtained system was subjected to high-speed centrifugation using a high-speed refrigerated centrifuge at 15,000 rpm to obtain polymer nanospheres. The polymer nanospheres were subjected to washing 5 times and then vacuum drying at 80 °C to obtain poly(p-methylstyrene) nanospheres B1.

150 g of the solution A1 and 75 g of the nanospheres B1 were mixed and then stirred at high speed for 30 min to obtain a uniform mixture, and then the uniform mixture was subjected to vacuum rotary evaporation to remove hydrolyzed small-molecular products. A resulting residue was subjected to gelling and solidification in air at room temperature and then aging for 48 h to obtain a catalyst alkaline skeleton C1.

30 g of the catalyst alkaline skeleton C1 was added into 250 mL of xylene. An obtained mixture was subjected to stirring at 1,000 rpm, leaching at −5 °C for 30 s, and then vacuum filtration to obtain a filter cake. And the filter cake was washed 3 times with cold xylene solvent. The leaching was repeated 4 times to remove the poly(p-methylstyrene) hard template as much as possible to obtain a product, marked as a catalyst precursor D1.

8 g of the catalyst precursor D1 was added into 200 mL of hexane, and 4 g of tetrapropyl zirconate was added under stirring at 80 °C under inert gas protection. Then the stirring was continued for 24 h. An obtained system was subjected to vacuum filtration to obtain a filter cake, and the filter cake was dried. An obtained dry filter cake was added to 200 mL of deionized water, and subjected to stirring at 1,000 rpm for 60 min, and then vacuum filtration to obtain a hydrolysis filter cake, and the hydrolysis filter cake was subjected to vacuum drying for 12 h to obtain a powder E1.

The powder E1 was impregnated with a 0.3 M alcohol solution of ammonium sulfate at room temperature under 800 rpm for 3 h. A resulting product was subjected to vacuum filtration to obtain a filter cake. The filter cake was subjected to vacuum drying at 120 °C for 8 h, and then calcination in a box furnace at 500 °C for 5 h to remove the polyether in the filter cake, thereby obtaining a solid acid-base bifunctional integrated catalyst of “mesoporous CaO-macroporous ZrSO₅”.

### Example 2

78 g of nonionic amphiphilic block copolymer (including 66 g of P123 and 12 g of F127) was added into 52 g of deionized water, and subjected to acidification to pH=0 with sulfuric acid, and then mixing evenly at 30 °C in a variable-speed vortex mixer. A resulting mixture was taken out and subjected to standing to allow self-assembly to form a lyotropic liquid crystal micelle. 15.9 g of Mg(NO₃)₂·6H₂O and 111 mL of TMOS were added thereto, and then stirred at 2,000 rpm for 20 min to form a uniform catalyst alkaline substrate solution A2 for later use.

The polymerization inhibitor in the polymer monomer styrene was removed by conventional process. And then 137 g of a purified polymer monomer was added into 1,370 mL of ultrapure water. Under inert gas protection, a redox initiator “hydrogen peroxide+L-ascorbic acid” system was added dropwise under stirring at 1,000 rpm. Amounts of the hydrogen peroxide and the L-ascorbic acid were 1% and 0.25% of a mass of the polymer monomer, respectively. The adding dropwise was conducted for 90 min with two stages. Each stage was conducted for 45 min, and the two stages were controlled at 75 °C and 85 °C, respectively. After the adding dropwise of the initiator was completed and before the polymer colloid nanospheres appeared, the stirring speed was 600 rpm. During the aging after the white polymer colloid nanospheres were formed, the stirring speed was 300 rpm. And the stirring was performed for 12 h during the aging. Then an obtained system was subjected to high-speed centrifugation using a high-speed refrigerated centrifuge at 20,000 rpm to obtain polymer nanospheres. The polymer nanospheres were subjected to washing 3 times and then vacuum drying at 120 °C to obtain polystyrene nanospheres B2.

150 g of the solution A2 and 100 g of the nanospheres B2 were mixed and then stirred at high speed for 25 min to obtain a uniform mixture, and then the uniform mixture was subjected to vacuum rotary evaporation to remove hydrolyzed small-molecular products. A resulting residue was subjected to gelling and solidification in air at room temperature and then aging for 24 h to obtain a catalyst alkaline skeleton C2.

30 g of the catalyst alkaline skeleton C2 was added into 227 mL of xylene. An obtained mixture was subjected to stirring at 800 rpm, leaching at −3 °C for 20 s, and then vacuum filtration to obtain a filter cake. And the filter cake was washed 2 times with cold xylene solvent. The leaching was repeated 6 times to remove the polystyrene hard template as much as possible to obtain a product, marked as a catalyst precursor D2.

8 g of the catalyst precursor D2 was added into 305 mL of isopropanol, and 2 g of tetrabutyl zirconate was added under stirring at 70 °C under inert gas protection. Then the stirring was continued for 24 h. An obtained system was subjected to vacuum filtration to obtain a filter cake, and the filter cake was dried. An obtained dry filter cake was added to 200 mL of deionized water, and subjected to stirring at 800 rpm for 60 min, and then vacuum filtration to obtain a hydrolysis filter cake, and the hydrolysis filter cake was subjected to vacuum drying for 12 h to obtain a powder E2.

The powder E2 was impregnated with a 0.4 M alcohol solution of ammonium sulfate at room temperature under 900 rpm for 2 h. A resulting product was subjected to vacuum filtration to obtain a filter cake. The filter cake was subjected to vacuum drying at 120 °C for 8 h, and then calcination in a box furnace at 700 °C for 4 h to remove the polyether in the filter cake, thereby obtaining a solid acid-base bifunctional integrated catalyst of “mesoporous MgO-macroporous ZrSO₅”.

### Example 3

35 g of nonionic amphiphilic block copolymer (including 28 g of P123 and 7 g of L62) was added into 52 g of deionized water, and then subjected to acidification to pH=3.0 with hydrochloric acid, and then mixing evenly at 40 °C in a variable-speed vortex mixer. A resulting mixture was taken out and subjected to standing to allow self-assembly to form a lyotropic liquid crystal micelle. 9.2 g of Ca(NO₃)₂·4H₂O and 78 mL of TPOS were added thereto, and then stirred at 1,000 rpm for 15 min to form a uniform catalyst alkaline substrate solution A3 for later use.

The polymerization inhibitor in the polymer monomer p-isobutylstyrene was removed by conventional process. And then 228 g of a purified polymer monomer was added into 1,370 mL of ultrapure water. Under inert gas protection, a redox initiator “ammonium persulfate+sodium bisulfite” system was added dropwise under stirring at 1,000 rpm. Amounts of the ammonium persulfate and sodium bisulfite were 5.6% and 1.4% of a mass of the polymer monomer, respectively. The adding dropwise was conducted for 60 min with two stages. Each stage was conducted for 30 min, and the two stages were controlled at 75 °C and 85 °C, respectively. After the adding dropwise of the initiator was completed and before the polymer colloid nanospheres appeared, the stirring speed was 600 rpm. During the aging after the white polymer colloid nanospheres were formed, the stirring speed was controlled at 300 rpm. And the stirring was performed for 12 h during the aging. Then an obtained system was subjected to high-speed centrifugation using a high-speed refrigerated centrifuge at 15,000 rpm to obtain polymer nanospheres. The polymer nanospheres were subjected to washing 6 times and vacuum drying at 60 °C to obtain poly(p-isobutylstyrene) nanospheres B3.

120 g of the solution A3 and 72 g of the nanospheres B3 were mixed and then stirred at high speed for 20 min to obtain a uniform mixture, and then the uniform mixture was subjected to vacuum rotary evaporation to remove hydrolyzed small-molecular products. A resulting residue was subjected to gelling and solidification in air at room temperature and then aging for 36 h to obtain a catalyst alkaline skeleton C3.

30 g of the catalyst alkaline skeleton C3 was added into 280 mL of toluene. An obtained mixture was subjected to stirring at 1,200 rpm, leaching at 0 °C for 20 s, and then vacuum filtration to obtain a filter cake. And the filter cake was washed 2 times with cold toluene solvent. The leaching was repeated 5 times to remove the poly(p-isobutylstyrene) hard template as much as possible to obtain a product, marked as a catalyst precursor D3.

8 g of the catalyst precursor D3 was added into 151 mL of cyclohexane, and 8 g of tetrabutyl titanate was added under stirring at 60 °C under inert gas protection. Then the stirring was continued for 36 h. An obtained system was subjected to vacuum filtration to obtain a filter cake, and the filter cake was dried. An obtained dry filter cake was added to 200 mL of deionized water, and subjected to stirring at 1,200 rpm for 60 min, and then vacuum filtration to obtain a hydrolysis filter cake, and the hydrolysis filter cake was subjected to vacuum drying for 12 h to obtain a powder E3.

The powder E3 was impregnated with a 0.1 M alcohol solution of ammonium sulfate at room temperature under 1,000 rpm for 6 h. A resulting product was subjected to vacuum filtration to obtain a filter cake. The filter cake was subjected to vacuum drying at 120 °C for 8 h, and then calcination in a box furnace at 400 °C for 6 h to remove the polyether in the filter cake, thereby obtaining a solid acid-base bifunctional integrated catalyst of “mesoporous CaO-macroporous TiSO₅”.

### Example 4

65 g of nonionic amphiphilic block copolymer (including 58 g of P123 and 7 g of F68) was added into 52 g of deionized water, and then subjected to acidification to pH=2.0 with acetic acid, and then mixing evenly at 60 °C in a variable-speed vortex mixer. A resulting mixture was taken out and subjected to standing to allow self-assembly to form a lyotropic liquid crystal micelle. 20.4 g of Mg(NO₃)₂·6H₂O and 253 mL of TBOS were added thereto, and then stirred at 2,000 rpm for 30 min to form a uniform catalyst alkaline substrate solution A4 for later use.

The polymerization inhibitor in the monomers ethyl acrylate, styrene, and p-methylstyrene was removed by conventional methods. And a block copolymer A(B-o-A)ₙB was synthesized with alkylphenol polyoxyethylene ether OP-10 as an emulsifier, ethyl acrylate as a coupling monomer, and styrene and p-methylstyrene as comonomers, where A and B represent styrene and p-methylstyrene, respectively, and o represented the coupling monomer ethyl acrylate. 151.2 g of purified styrene monomer, 19 g of p-methylstyrene monomer, 6.8 g of ethyl acrylate monomer, and 1.7 g of alkylphenol polyoxyethylene ether (OP-10) were added into 1370 mL of ultrapure water. Under inert gas protection, a redox initiator “ammonium persulfate+sodium bisulfite” system was added dropwise under stirring at 1,000 rpm. Amounts of the ammonium persulfate and sodium bisulfite were 4% and 1% of a mass of the polymer monomer, respectively. The adding dropwise was conducted for 60 min at 80 °C. After the adding dropwise of the initiator was completed and before the polymer colloid nanospheres appeared, the stirring speed was controlled at 600 rpm. During the aging after the white polymer colloid nanospheres were formed, the stirring speed was at 250 rpm. And the stirring was performed for 12 h during the aging. Then an obtained system was subjected to high-speed centrifugation using a high-speed refrigerated centrifuge at 20,000 rpm to obtain polymer nanospheres. The polymer nanospheres were subjected to washing 5 times and vacuum drying at 80 °C to obtain block copolymer nanospheres B4.

150 g of the solution A4 and 83 g of the nanospheres B4 were mixed and the stirred at high speed for 15 min to a uniform mixture, and then the uniform mixture was subjected to vacuum rotary evaporation to remove hydrolyzed small-molecular products. A resulting residue was subjected to gelling and solidification in air at room temperature and then aging for 72 h to obtain a catalyst alkaline skeleton C4.

30 g of the catalyst alkaline skeleton C4 was added into 262 mL of toluene. An obtained mixture was subjected to stirring at 1,000 rpm, leaching at 0 °C for 40 s, and then vacuum filtration to obtain a filter cake. And the filter cake was washed 3 times with cold toluene solvent. The leaching was repeated 3 times to remove the block copolymer hard template as much as possible to obtain a product, marked as a catalyst precursor D4.

8 g of the catalyst precursor D4 was added into 253 mL of cyclohexane, and 5 g of tetraisopropyl zirconate was added under stirring at 50 °C under inert gas protection. Then the stirring was continued for 48 h. An obtained system was subjected to vacuum filtration to obtain a filter cake, and the filter cake was dried. An obtained dry filter cake was added to 200 mL of deionized water, and subjected to stirring at 900 rpm for 60 min, and then vacuum filtration to obtain a hydrolysis filter cake, and the hydrolysis filter cake was subjected to vacuum drying for 12 h to obtain a powder E4.

The powder E4 was impregnated with a 0.2 M alcohol solution of ammonium sulfate at room temperature under 1,200 rpm for 5 h. A resulting product was subjected to vacuum filtration to obtain a filter cake. The filter cake was subjected to vacuum drying at 120 °C for 8 h, and then calcination in a box furnace at 600 °C for 4 h to remove the polyether in the filter cake, thereby obtaining the solid acid-base bifunctional integrated catalyst of “mesoporous MgO-macroporous ZrSO₅”.

### Comparative Example 1

56 g of nonionic amphiphilic block copolymer (including 48 g of P123 and 8 g of P103) was added into 52 g of deionized water, and then subjected to acidification to pH=1.0 with nitric aci, and then mixing evenly at 50 °C in a variable-speed vortex mixer. A resulting mixture was taken out and subjected to standing to allow self-assembly to form a lyotropic liquid crystal micelle. 14.2 g of Ca(NO₃)₂·4H₂O and 185 mL of TEOS were added thereto, and then stirred at 1,500 rpm for 25 min to form a uniform catalyst alkaline substrate solution a1 for later use.

The polymerization inhibitor in the polymer monomer p-methylstyrene was removed by conventional process. And then 168 g of a purified polymer monomer was added into 1,370 mL of ultrapure water. Under inert gas protection, a redox initiator “ammonium persulfate+sodium bisulfite” system was added dropwise under stirring at 1,000 rpm. Amounts of the ammonium persulfate and sodium bisulfite were 3% and 0.7% of a mass of the polymer monomer, respectively. The adding dropwise was conducted for 90 min with three stages. Each stage was conducted for 30 min, and the three stages were controlled at 75 °C, 80 °C, and 85 °C, respectively. After the adding dropwise of the initiator was completed and before the polymer colloid nanospheres appeared, the stirring speed was controlled at 600 rpm. During the aging after the white polymer colloid nanospheres were formed, the stirring speed was controlled at 200 rpm. And the stirring was performed for 12 h during the aging. Then an obtained system was subjected to high-speed centrifugation using a high-speed refrigerated centrifuge at 15,000 rpm to obtain polymer nanospheres. The polymer nanospheres were subjected to washing 5 times and vacuum drying at 80 °C to obtain poly(p-methylstyrene) nanospheres b1.

150 g of the solution a1 and 75 g of the nanospheres b1 were mixed and then stirred at high speed for 30 min to obtained a uniform mixture. and then the uniform mixture was subjected to vacuum rotary evaporation to remove hydrolyzed small-molecular products. A resulting residue was subjected to gelling and solidification in air at room temperature and then aging for 48 h to obtain a catalyst alkaline skeleton c1.

30 g of the catalyst alkaline skeleton c1 was added into 250 mL of xylene. An obtained mixture was subjected to stirring at 1,000 rpm, leaching at −5 °C for 30 s, and then vacuum filtration to obtain a filter cake. And the filter cake was washed 3 times with cold xylene solvent. The leaching was repeated 4 times to remove the poly(p-methylstyrene) hard template as much as possible to obtain a product, marked as a catalyst precursor d1. The catalyst precursor d1 was subjected to vacuum drying at 120 °C for 8 h, and then calcination in a box furnace at 500 °C for 5 h to remove the polyether therein, thereby obtaining a mesoporous solid base catalyst of “mesoporous CaO-macropores unmodified”.

### Comparative Example 2

56 g of nonionic amphiphilic block copolymer (including 48 g of P123 and 8 g of P103) was added into 52 g of deionized water, and then subjected to acidification to pH=1.0 with nitric acid, mixing evenly at 50 °C in a variable-speed vortex mixer. A resulting mixture was taken out and subjected to standing to allow self-assembly to form a lyotropic liquid crystal micelle. 185 mL of TEOS was added thereto, and then stirred at 1,500 rpm for 25 min to form a uniform catalyst substrate solution a2 for later use.

The polymerization inhibitor in the polymer monomer p-methylstyrene was removed by conventional process. And then 168 g of a purified polymer monomer was added into 1,370 mL of ultrapure water. Under inert gas protection, a redox initiator “ammonium persulfate+sodium bisulfite” system was added dropwise under stirring at 1,000 rpm. Amounts of the ammonium persulfate and sodium bisulfite were 3% and 0.7% of a mass of the polymer monomer, respectively. The adding dropwise was conducted for 90 min with three stages. Each stage was conducted for 30 min, and the three stages were controlled at 75 °C, 80 °C, and 85 °C, respectively. After the adding dropwise of the initiator was completed and before the polymer colloid nanospheres appeared, the stirring speed was controlled at 600 rpm. During the aging after the white polymer colloid nanospheres were formed, the stirring speed was controlled at 200 rpm. And the stirring was performed for 12 h during the aging. Then an obtained system was subjected to high-speed centrifugation using a high-speed refrigerated centrifuge at 15,000 rpm to obtain polymer nanospheres. The polymer nanospheres were subjected to washing 5 times and vacuum drying at 80 °C to obtain poly(p-methylstyrene) nanospheres b2.

150 g of the solution a2 and 75 g of the nanospheres b2 were mixed and stirred at high speed for 30 min to obtain a uniform mixture, and then the uniform mixture was subjected to vacuum rotary evaporation to remove hydrolyzed small-molecular products. A resulting residue was subjected to gelling and solidification in air at room temperature and then aging for 48 h to obtain a catalyst skeleton c2.

30 g of the catalyst skeleton c2 was added into 250 mL of xylene. An obtained mixture was subjected to stirring at 1,000 rpm, leaching at −5 °C to for 30 s, and then vacuum filtration to obtain a filter cake. And the filter cake was washed 3 times with cold xylene solvent. The leaching was repeated 4 times to remove the poly(p-methylstyrene) hard template as much as possible to obtain a product, marked as a catalyst precursor d2.

8 g of the catalyst precursor d2 was added into 200 mL of hexane, and 4 g of tetrapropyl zirconate was added under stirring at 80 °C under inert gas protection. Then the stirring was continued for 24 h. An obtained system was subjected to vacuum filtration to obtain a filter cake, and the filter cake was dried. An obtained dry filter cake was added to 200 mL of deionized water, and subjected to stirring at 1,000 rpm for 60 min, and then vacuum filtration to obtain a hydrolysis filter cake, and the hydrolysis filter cake was subjected to vacuum drying for 12 h to obtain a powder e2.

The powder e2 was impregnated with a 0.3 M alcohol solution of ammonium sulfate at room temperature under 800 rpm for 3 h. and was subjected to vacuum filtration to obtain a filter cake. The filter cake was vacuum dried at 120 °C for 8 h. A resulting dry filter cake was then calcination in a box furnace at 500 °C for 5 h to remove the polyether therein, thereby obtaining the a macroporous solid acid catalyst of “mesopores unmodified-macroporous ZrSO₅”.

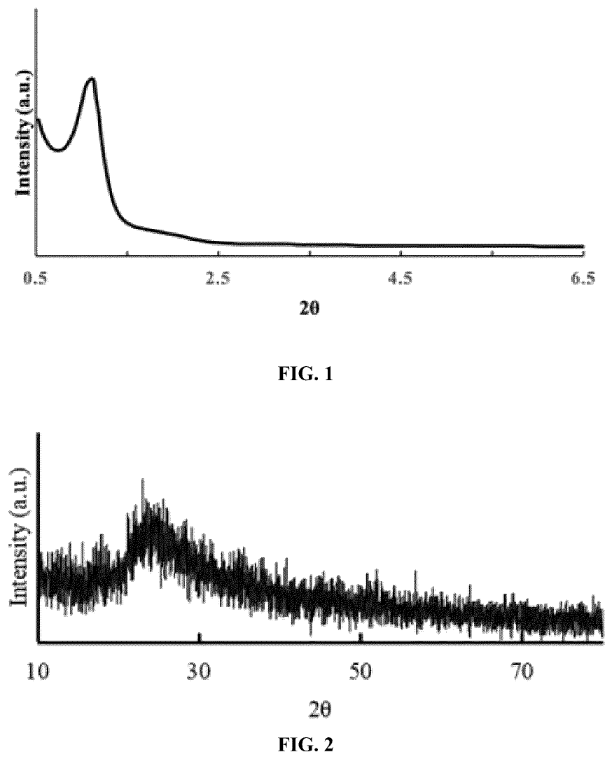

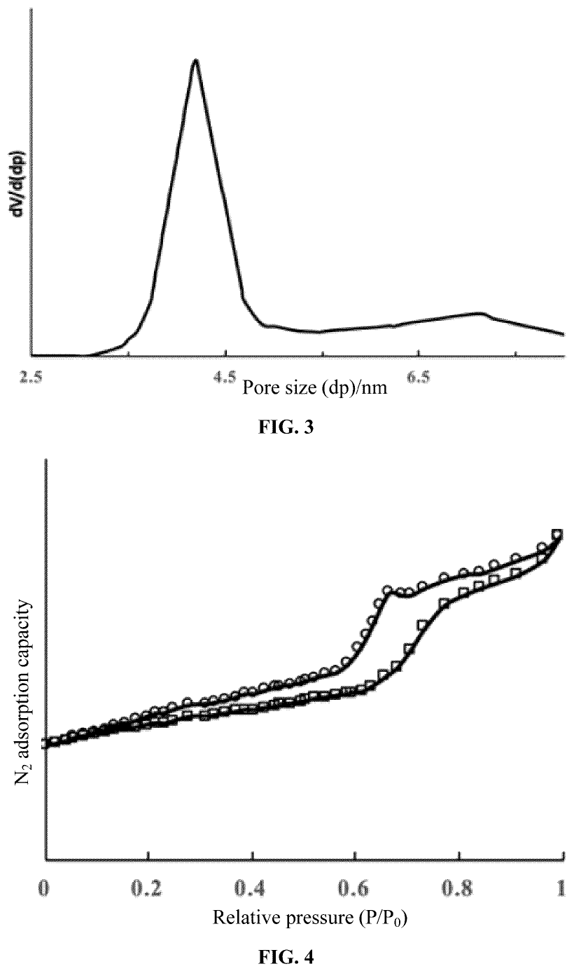

The element content was determined using an element analyzer (Table 2). The specific surface area (SSA) and pore structure characteristics of the catalyst were tested using the Brunauer-Emmett-Teller (BET) nitrogen adsorption method and the mercury injection method (FIG. 3 and FIG. 4, Table 1). The crystal phase and pore characteristics of the material were analyzed using XRD (FIG. 1 and FIG. 2). The acidic and basic site loading capacities were calculated using titration analysis (Table 2).

TABLE 1
Specific surface area (SSA) and pore structure parameters of the catalysts

| | | Total pore | Mesopore | Mesopore | Macropore | Macropore |
|---|---|---|---|---|---|---|
| Catalyst | | volume | volume | diameter | volume | diameter |
| Number | SSA (m²/g) | (cm³/g) | (cm³/g) | (nm) | (cm³/g) | (nm) |
| Example 1 | 421 | 0.6 | 0.2 | 4.2 | 0.4 | 50-340 |
| Example 2 | 392 | 0.5 | 0.1 | 4.1 | 0.4 | 50-370 |
| Example 3 | 410 | 0.6 | 0.2 | 4.1 | 0.4 | 50-360 |
| Example 4 | 418 | 0.6 | 0.2 | 4.2 | 0.4 | 50-340 |
| Comparative | 446 | 0.7 | 0.2 | 4.1 | 0.5 | 50-310 |
| Example 1 | | | | | | |
| Comparative | 470 | 0.7 | 0.3 | 4.1 | 0.4 | 50-300 |
| Example 2 | | | | | | |

TABLE 2
Active element ratios and active site loading capacities of the
catalysts

| | | Active site loading | |
|---|---|---|---|
| | | capacity (μmol/g) | |
| Catalyst SN | Active element ratio (wt %) | Acidic site | Basic site |
| Example 1 | Ca: 1.51; Zr: 1.80; S: 1.02 | 62 | 118 |
| Example 2 | Mg: 1.25; Zr: 1.90; S: 1.05 | 42 | 144 |
| Example 3 | Ca: 1.45; Ti: 1.88; S: 1.04 | 53 | 135 |
| Example 4 | Mg: 1.47; Zr: 1.85; S: 1.0 | 57 | 126 |
| Comparative | Ca: 1.72 | 78 | — |
| Example 1 | | | |
| Comparative | Zr: 1.85; S: 0.94 | — | 132 |
| Example 2 | | | |

It can be seen form Table 1 that the solid acid-base integrated catalysts prepared in the present disclosure has mesoporous and macroporous structures and large specific surface areas, making the structural material has the basic conditions to become a catalyst with excellent performance.

The elemental analysis data and active site loading capacities in Table 2 show that the catalyst in Comparative Example 1 has only basic sites and could only catalyze transesterification; while the catalyst in Comparative Example 2 has only acidic sites and could only catalyze esterification.

The catalyst prepared in Example 1 was tested, and the results are shown in FIG. 1 to FIG. 4.

As shown in the small-angle XRD pattern in FIG. 1, the strongest diffraction peak located near the diffraction angle of 1.1° is clearly seen. This peak is a characteristic peak of the (100) crystal plane of the SBA-15 mesoporous material, indicating that the SBA-15 mesoporous channel structure has been successfully prepared in the catalyst.

As shown in the wide-angle XRD pattern in FIG. 2, it can be clearly seen that there were no crystalline characteristic peaks of Ca and Zr compounds, indicating that they exist in a highly dispersed amorphous state in the synthesized catalyst.

The BET nitrogen adsorption method produced a pore size distribution diagram shown in FIG. 3, indicating that the mesopore size data is consistent with the results in Table 1, which is a typical SBA-15 mesopore size. The mercury intrusion method was mainly used to determine the macropore parameters in the material, and relevant results are shown in Table 1. It can be further confirmed from these data that mesoporous and macroporous structures have indeed been prepared in the catalyst.

The BET nitrogen adsorption method also produced a N₂ physical adsorption-desorption isotherm curve shown in FIG. 4, which is a type IV adsorption-desorption isotherm curve with an H1 type hysteresis loop. This is a typical feature of the SBA-15 mesoporous material with relatively narrow pore size distribution, further confirming that the mesoporous structure has indeed been prepared in the catalyst.

### Catalyst Performance Test:

The basic composition and main parameters of cottonseed oil I (low acid value sample) and cottonseed oil II (high acid value sample, obtained by uniformly mixing cottonseed oil I and oleic acid at a mass ratio of 5:1) used in the following examples are shown in Table 3.

TABLE 3
Composition parameters of the cottonseed oil used in the catalyst
performance test

| | | Cottonseed oil II |
|---|---|---|
| Item | Cottonseed oil I | (high acid value) |
| Color | Orange-yellow, | Orange-yellow, |
| | transparent | transparent |
| Relative density | 0.92 | 0.915 |
| Moisture content (wt %) | 0.2 | 0.16 |
| Acid value (based on KOH, mg/g) | 1.0 | 33.26 |
| Insoluble impurities (wt %) | 0.2 | 0.16 |
| Saturated fatty acid ester | 26.3 | 21.9 |
| composition (wt %) | | |
| Palmitate (C16:0) | 22.5 | 18.75 |
| Stearate (C18:0) | 2.5 | 2.08 |
| Myristate (C14:0) | 0.6 | 0.50 |
| Arachidate (C20:0) | 0.5 | 0.42 |
| Behenate (C22:0) | 0.2 | 0.17 |
| Monounsaturated fatty acid ester | 19.8 | 16.50 |
| composition (wt %) | | |
| Oleate (C18:1) | 18.9 | 15.75 |
| Palmitoleate (C16:1) | 0.8 | 0.67 |
| (C22:1) | 0.1 | 0.08 |
| Polyunsaturated fatty acid ester | 53.5 | 44.59 |
| composition (wt %) | | |
| Linoleate (C18:2) | 53.3 | 44.42 |
| Linolenate (C18:3) | 0.2 | 0.17 |
| Oleic acid (wt %) | — | 16.67 |

### Example 5

60 g of the cottonseed oil I (with an acid value of 1.0) was added into a reaction test device, and then 605 mL of isooctyl alcohol and 8.4 g of the catalyst (the catalyst prepared in Example 1) were added thereto. A resulting mixture was heated to 70 °C by programming and stirred magnetically, and conducted a reaction for 6 h. A resulting reaction product was subjected to vacuum filtration to remove the catalyst. A resulting filtrate was subjected to standing to obtain an upper layer and a lower layer. The upper layer mainly included fatty acid isooctyl ester and isooctyl alcohol, and the lower layer mainly included glycerol and isooctyl alcohol. The upper oil phase was subjected to molecular distillation to recover the isooctyl alcohol, and the acid value and the transesterification conversion rate were measured (specific data are shown in Table 4). An obtained product was subjected to adsorption decolorization, filtration and other processes to obtain a refined fatty acid isooctyl ester product.

### Comparative Example 3

The catalyst was the catalyst prepared in Comparative Example 1, and the other steps were the same as those in Example 5.

### Comparative Example 4

The catalyst was the catalyst prepared in Comparative Example 2, and the other steps were the same as those in Example 5.

### Example 6

60 g of the cottonseed oil II (obtained by mixing evenly 50 g of the cottonseed oil I and 10 g of oleic acid) was added into a reaction rectification test device, mixed well by stirring (acid value 33.26), and then 605 mL of isooctyl alcohol and 8.4 g of the catalyst (the catalyst prepared in Example 1) were added. A resulting mixture was heated to 95 °C by programming and subjected to stirring magnetically. The reaction distillation test device was maintained at a certain negative pressure to evaporate the water generated by the esterification in time. and the reaction distillation was conducted for 6 h. A resulting reaction product was subjected to vacuum filtration to remove the catalyst. And a filtrate was subjected to standing to obtain an upper layer and a lower layer. The upper layer mainly included fatty acid isooctyl ester, isooctyl alcohol, and trace oleic acid, and a lower layer mainly included glycerol, isooctyl alcohol, and trace water. The upper oil phase was subjected to molecular distillation to recover the isooctyl alcohol, and the acid value, oleic acid conversion rate, and transesterification conversion rate were measured (specific data are shown in Table 4). An obtained product was subjected to alkali refining (removing unreacted oleic acid), water washing, adsorption decolorization, filtration, water removal and other processes to obtain a refined fatty acid isooctyl ester product.

### Comparative Example 5

The catalyst was the catalyst prepared in Comparative Example 1, and the other steps were the same as those in Example 6.

### Comparative Example 6

The catalyst was the catalyst prepared in Comparative Example 2, and the other steps were the same as those in Example 6.

TABLE 4
Comparisons of catalytic performance of different catalysts for the
transesterification and the esterification of the cottonseed oil

| | Acid value of crude | Cottonseed oil | Oleic acid |
|---|---|---|---|
| | fatty acid ester | conversion rate | conversion rate |
| Example SN | (6 h, mgKOH/g) | (6 h, %) | (6 h, %) |
| Example 5 | 0.05 | 97.1 | — |
| Comparative | 0.49 | 97.4 | — |
| Example 3 | | | |
| Comparative | 0.05 | 8.0 | — |
| Example 4 | | | |
| Example 6 | 0.65 | 96.8 | 96.2 |
| Comparative | 28.8 | 10.6 | 4.5 |
| Example 5 | | | |
| Comparative | 1.02 | 7.6 | 96.5 |
| Example 6 | | | |

The following conclusions are drawn from the data in Table 4:
(1) When cottonseed oil was used as low acid value raw material I, the catalytic performance (Comparative Example 3) of the catalyst prepared in Comparative Example 1 (with only basic sites and no acidic sites) is comparable to the catalytic performance (Example 5) of the “mesoporous CaO-macroporous ZrSO₅” solid acid-base dual-functional integrated catalyst higher than 97%. And the acid values of the crude fatty acid ester obtained by the reaction are all extremely low, about 0.05 mgKOH/g, proving that both catalysts have excellent catalytic performance. However, the catalyst prepared in Comparative Example 2 (with only acidic sites and no basic sites) has extremely poor catalytic performance for the transesterification reaction of cottonseed oil, and the transesterification conversion rate was only 8%. This indicates that the strong catalytic activity in the transesterification of cottonseed oil is attributed to the alkaline sites.
(2) When cottonseed oil was the high acid value raw material II, the catalytic performance of the catalyst prepared in Example 1 for the transesterification of cottonseed oil (Example 6) is equivalent to that of Example 5, and the conversion rate slightly decreased from 97.1% to 96.8%, and the conversion rate of the oleic acid esterification is also as high as 96.2%. This is because Example 1 prepared a solid acid-base integrated catalyst, in which the basic site catalyzed the transesterification, and the acidic site catalyzed the esterification of free fatty acids, and the presence of free fatty acids does not affect the catalytic activity of the catalyst for the transesterification of cottonseed oil. The reason lies in that the acid and basic active sites of the prepared catalyst were separated in space. Specifically, the acidic sites are distributed in the macropores on the surface and while the alkaline sites are distributed in the mesopores inside the. The high acid value cottonseed oil first contacts the acidic sites in the macropores, where the free fatty acids are basically esterified, and then diffuse into the mesopores through the channels between the macropores and the mesopores, where the transesterification of cottonseed oil occurred. The time sequence of the reaction brings about by this spatial sequence is critical to avoiding the poisoning and inactivation of active basic sites caused by free fatty acids. In contrast, the catalytic performance of the catalyst prepared in Comparative Example 1 (with only basic sites and no acidic sites) for the transesterification of cottonseed oil with high acid value is greatly reduced (Comparative Example 5), and the transesterification conversion rate is only 10.6%, which is far inferior to its catalytic conversion rate of 97.4% for the transesterification of cottonseed oil with low acid value. This indicates that on the catalyst lacking acidic sites, a large number of free fatty acids could not be esterified, thereby covering the active basic sites to poison and inactivate these sites. Similar to Comparative Example 4, the catalyst prepared in Comparative Example 2 (with only acidic sites and no basic sites) also has poor catalytic performance for the transesterification of cottonseed oil with high acid value (Comparative Example 6). And the transesterification conversion rate is only 7.6%, but its catalytic performance for the esterification of free fatty acids is extremely high, and the esterification conversion rate of oleic acid could reach 96.5%.

### Example 7

The performance attenuation characteristics of the solid acid-base dual-functional integrated catalyst during repeated use were investigated under the experimental conditions of Example 5. The catalyst separated by filtration was vacuum dried in an oven at 120 °C for 12 h and then used for the next transesterification. After being reused 8 times, the transesterification conversion rate of the cottonseed oil reduces to 72.3%.

### Example 8

The performance attenuation characteristics of the solid acid-base dual-functional integrated catalyst during repeated use were investigated under the experimental conditions of Example 5. The catalyst separated by vacuum filtration was washed 3 times with methanol, vacuum dried in an oven at 120 °C for 12 h, and then used for the next transesterification. After being reused 8 times, the transesterification conversion rate of the cottonseed oil reduces to 92.8%. The catalyst was placed in a box furnace at 400 °C, heat-treated with hot air for 30 min, taken out and naturally cooled to room temperature, and then used again in the experiment of Example 5. The transesterification conversion rate of the cottonseed oil rebounds to 96.8%.

### Example 9

The performance attenuation characteristics of the solid acid-base dual-functional integrated catalyst during repeated use were investigated under the experimental conditions of Example 6. The catalyst separated by vacuum filtration was vacuum dried in an oven at 120 °C for 12 h and then used for the next catalysis. After being reused 8 times, the transesterification conversion rate and oleic acid conversion rate of the cottonseed oil reduce to 71.4% and 70.6%, respectively.

### Example 10

The performance attenuation characteristics of the solid acid-base dual-functional integrated catalyst during repeated use were investigated under the experimental conditions of Example 6. The catalyst separated by vacuum filtration was washed 3 times with methanol, vacuum dried in an oven at 120 °C for 12 h, and then used for the next catalysis. After being reused 8 times, the transesterification conversion rate and oleic acid conversion rate of the cottonseed oil reduce to 90.5% and 89.4%, respectively. The catalyst was placed in a box furnace at 400 °C, heat-treated with hot air for 30 min, taken out and naturally cooled to room temperature, and then used again in the experiment of Example 6. The transesterification conversion rate and oleic acid conversion rate of the cottonseed oil increase to 95.7% and 95.1%, respectively.

It can be seen from the experimental results in Examples 7 to 10 that the solid acid-base integrated catalyst prepared in the present disclosure has a slow performance decay during repeated use. If the catalyst was “washed several times with alcohol solvent” after each separation, a better catalytic performance could be maintained. If being heat-treated with medium-temperature air after reuse for 8 times, the catalytic performance of catalyst could be restored to the level of a fresh catalyst.

### Example 11

The refined fatty acid isooctyl ester product obtained in Example 6 was blended with frozen refined cottonseed oil in proportion. And 0.5% of an antioxidant tertiary butyl hydroquinone, 0.3% of a metal passivator benzotriazole, and 1% of a narrow molecular weight copolymer composite pour point depressant were added to obtain a cottonseed oil-based insulating oil product for transformer. The physical, chemical, thermal, and electrical performances of the product were tested according to international/domestic/industry standards, and the relevant technical parameters are shown in Table 5.

TABLE 5
Performance parameters of cottonseed oil-based insulating oil product for transformer

| | | | |
|---|---|---|---|
| | | | Product of the |
| Characteristic parameter | Test method | ASTM D6871 | present disclosure |

Electrical performance

| Breakdown voltage (kV/2.5 mm) | | IEC 156 | ≥35 | 68 |
|---|---|---|---|---|
| Dielectric loss factor | 25 °C | ASTM D924 | ≤0.2 | 0.02 |
| | 100 °C | ASTM D924 | ≤4 | 1.15 |

Physical and chemical performances

| Relative density (g cm⁻³@15 °C) | | ASTM D1298 | ≤0.96 | 0.96 |
|---|---|---|---|---|
| Chromaticity/No. | | ASTM D1500 | ≤1.0 | 0.1 |
| Acid value (mg • KOH/g) | | ASTM D974 | ≤0.06 | 0.02 |
| Kinematic viscosity | 40 °C | GB/T 265 | ≤50 | 36 |
| (mm²/s) | 100 °C | GB/T 265 | ≤15 | 6 |

| | | | |
|---|---|---|---|
| Flash point (open)/°C | GB/T 3536 | ≥275 | 280 |
| Ignition point/°C | GB/T 3536 | ≥300 | 313 |
| Pour point/°°C | GB/T 3536 | ≤10 | −35 |

It can be seen form the data in Table 5 that the cottonseed oil-based insulating oil product for transformer prepared in the present disclosure has excellent performance, and all parameters meet the specified range of international/domestic/industry technical standards. In particular, its breakdown voltage (2.5 mm) could reach 68 kV, and its electrical performance is excellent; the flash point is 280 °C, and the ignition point is 313 °C, which are much higher than those of mineral insulating oil. Moreover, the cottonseed oil-based insulating oil product for transformer prepared in the present disclosure exhibits excellent fire resistance and high safety performance; the pour point reaches −35 °C, which could be used in working conditions with strict requirements on low-temperature performance, such as power supply and substation systems in Northeast China, Northwest China, and Qinghai-Tibet Plateau.

In summary, the solid acid-base bifunctional integrated catalyst prepared by the present disclosure has a hierarchical structure of macropores and mesopores, and the active acidic and basic sites are separated in the catalyst pore structure, located in the macropores and mesopores, respectively. In the one-pot transesterification, the catalyst can effectively prevent catalyst poisoning and deactivation caused by excessively high raw material acid value (high free fatty acid content), and reducing the restriction requirements on the raw material acid value.

The objectives, technical solutions, and beneficial effects of the present disclosure are further described in detail in the foregoing specific embodiments. It should be understood that the foregoing descriptions are merely specific embodiments of the present disclosure, but are not intended to limit the scope of the present disclosure. Any modification, equivalent replacement, or improvement made within the spirit and principle of the present disclosure shall fall within the scope of the present disclosure.

1. A method for preparing a solid acid-base catalyst for producing an insulating oil of a transformer, comprising the following steps:
(1) constructing a catalyst alkaline skeleton
(a), preparing a catalyst alkaline substrate
adding an amphiphilic block copolymer into deionized water, subjecting a resulting solution to acidification by adding an acid, mixing, and subjecting a resulting mixture to standing to allow self-assembly to form a lyotropic liquid crystal micelle, and then adding a metal nitrate and a silicate into the lyotropic liquid crystal micelle and stirring to obtain a catalyst alkaline substrate solution A;
(b), preparing a monodisperse polymer colloid nanosphere used as a macroporous template
adding an initiator dropwise into a polymer monomer and ultrapure water under inert gas protection and stirring, and conducting a reaction to obtain white polymer colloid nanospheres, and subjecting the white polymer colloid nanospheres to washing and then vacuum drying to obtain nanospheres B; alternatively,
adding an initiator dropwise into a polymer monomer, a coupling monomer, an emulsifier, and ultrapure water under inert gas protection and stirring, and conducting a reaction to obtain white polymer colloid nanospheres, and then subjecting the white polymer colloid nanospheres to washing and then vacuum drying to obtain nanospheres B; and
(c), blending and gelling the catalyst alkaline substrate and the macroporous template, mixing the catalyst alkaline substrate solution A and the nanospheres B, and subjecting a resulting system to homogenization by stirring, and then aging to obtain a catalyst alkaline skeleton C; and
(2) leaching the macroporous template in the catalyst alkaline skeleton C and loading a solid superacid active site
(a), leaching the macroporous template in the catalyst skeleton
adding the catalyst alkaline skeleton C into a solvent of a polymer hard template, subjecting an obtained mixture to stirring, leaching, and a first vacuum filtration in sequence, and then washing an obtained filter cake to obtain a catalyst precursor D in which the microporous template is removed; and
(b), loading an acidic active site in a catalyst
adding the catalyst precursor D into an organic solvent, adding an organic metal compound under inert gas protection and stirring, conducting a reaction, and subjecting a resulting reaction product to a second vacuum filtration to obtain a first filter cake, and then drying the first filter cake to obtain a dry filter cake;
subjecting the dry filter cake to hydrolysis to obtain a hydrolysis filter cake, and then subjecting the hydrolysis filter cake to vacuum drying to obtain a powder E; and
impregnating the powder E with an alcohol solution of ammonium sulfate under stirring at room temperature, subjecting an obtained system to a third vacuum filtration to obtain a second filter cake, and then subjecting the second filter cake to vacuum drying and calcination in sequence to remove a polyether in the second filter cake to obtain the solid acid-base catalyst for producing the insulating oil of the transformer; wherein
the amphiphilic block copolymer in (a) of step (1) is a polyether having a structure of poly(ethylene oxide) (PEO)-poly(propylene oxide) (PPO)-PEO;
a molar ratio of the amphiphilic block copolymer, the metal nitrate, and the silicate in (a) of step (1) is in a range of 1:5-8:60-110;
a mass ratio of the catalyst alkaline substrate solution A to the nanospheres B in (c) of step (1) is in a range of 3:2 to 4:2;
in (b) of step (2), the organic metal compound is one or two selected from the group consisting of an organic titanium compound and an organic zirconium compound, and a mass ratio of the catalyst precursor D to the organic metal compound is in a range of 1:1 to 4:1; and
in (b) of step (2), the reaction is conducted at a temperature of 50 °C to 80 °C for 24 hours to 48 hours, the impregnating is conducted for 2 hours to 6 hours, the calcination is conducted at a temperature of 400 °C to 700 °C for 4 hours to 6 hours, and the alcohol solution of the ammonium sulfate has a concentration of 0.1 mol/L to 0.4 mol/L.

2. The method of claim 1, wherein, in (a) of step (1), the acid is selected from the group consisting of an inorganic acid and an organic acid, a resulting acidified solution after the acidification has a pH value of 0 to 3, the mixing is conducted at a temperature of room temperature to 60 °C, and a mass ratio of the deionized water to the amphiphilic block copolymer is in a range of 3:2 to 3:4.5.

3. The method of claim 1, wherein in (a) of step (1), the metal nitrate is selected from the group consisting of an alkaline earth metal nitrate, a transition metal nitrate, and a rare earth metal nitrate.

4. The method of claim 1, wherein in (a) of step (1), the silicate is one or more selected from the group consisting of tetramethyl orthosilicate (TMOS), tetraethyl orthosilicate (TEOS), tetrapropyl orthosilicate (TPOS), and tetrabutyl orthosilicate (TBOS); and
the stirring is conducted at a speed of 1,000 rpm to 2,000 rpm for 15 minutes to 30 minutes.

5. The method of claim 1, wherein in (b) of step (1),
the polymer monomer is one or more selected from the group consisting of styrene, α-methylstyrene, p-methylstyrene, vinyltoluene, p-isobutylstyrene, and p-tert-butylstyrene;
the coupling monomer is selected from the group consisting of maleic anhydride and acrylate;
the emulsifier is selected from the group consisting of alkylphenol polyoxyethylene ether OP-10 and sodium dodecyl sulfate;
the initiator is selected from the group consisting of a single initiator and a composite initiator, wherein the single initiator is selected from the group consisting of potassium persulfate, ammonium persulfate, and hydrogen peroxide, the composite initiator is a redox initiation system, an oxidant in the redox initiation system is selected from the group consisting of the potassium persulfate, the ammonium persulfate, and the hydrogen peroxide, and a reductant in the redox initiation system comprises one or more selected from the group consisting of sodium sulfite, sodium bisulfite, sodium hyposulfite, and L-ascorbic acid; and
a mass ratio of the polymer monomer to the ultrapure water is in a range of 1:6 to 1:10.

6. The method of claim 5, wherein in (b) of step (1),
an amount of the coupling monomer is 1.5% to 6% of a total mass of the polymer monomer;
an amount of the emulsifier is 0.5% to 2% of the total mass of the polymer monomer; and
an amount of the initiator is 0.1% to 7% of the total mass of the polymer monomer.

7. The method of claim 1, wherein in (b) of step (1), the reaction is conducted at a temperature of 75 °C to 85 °C, the washing is conducted 3 times to 6 times, and the vacuum drying is conducted at a temperature of 60 °C to 120 °C.

8. The method of claim 1, wherein in (c) of step (1), the stirring is conducted for 15 minutes to 30 minutes, and the aging is conducted for 24 hours to 72 hours.

9. The method of claim 1, wherein in (a) of step (2),
the solvent is selected from the group consisting of toluene, xylene, N,N-dimethylformamide (DMF), tetrahydrofuran (THF), acetone, dichloromethane (DCM), and chloroform;
the leaching is conducted at a temperature of −5 °C to 0 °C for 20 seconds to 40 seconds;
the washing is conducted 2 times to 3 times with a cold solvent;
a mass ratio of the catalyst alkaline skeleton C to the solvent is in a range of 1:6.5 to 1:9; and
the stirring is conducted at a speed of 800 rpm to 1,200 rpm.

10. The method of claim 1, wherein, in (b) of step (2),
the organic solvent is selected from the group consisting of cyclohexane, hexane, carbon tetrachloride, propanol, isopropanol, tetrahydrofuran (THF), ethyl acetate, chloroform, methyl ethyl ketone, and acetone;
the organic titanium compound is selected from the group consisting of tetraethyl titanate, tetraisopropyl titanate, tetrapropyl titanate, and tetrabutyl titanate;
the organic zirconium compound is selected from the group consisting of tetraethyl zirconate, tetrapropyl zirconate, tetraisopropyl zirconate, and tetrabutyl zirconate; and
a mass ratio of the catalyst precursor D to the organic solvent is in a range of 1:14 to 1:30.

11. A catalyst prepared by the method of claim 1, wherein the catalyst has interconnected macropores and mesopores, and the macropores are present on a surface of the catalyst in an open structure, the mesopores are distributed between the macropores, and acidic and basic active sites are highly dispersed in a form of an oxide inside the macropores and the mesopores, respectively.

12. A method of using the catalyst of claim 11, comprising using the catalyst in production of an insulating oil for a transformer by transesterification of a vegetable oil, wherein the production of the insulating oil for the transformer by the transesterification of the vegetable oil is conducted through one-pot transesterification at a temperature of 95 °C for 6 hours.

13. The method of claim 12, wherein the vegetable oil is a cottonseed oil.

14. (canceled)

15. (canceled)

16. The method of claim 5, wherein in (b) of step (1), the reaction is conducted at a temperature of 75 °C to 85 °C, the washing is conducted 3 times to 6 times, and the vacuum drying is conducted at a temperature of 60 °C to 120 °C.

17. The method of claim 6, wherein in (b) of step (1), the reaction is conducted at a temperature of 75 °C to 85 °C, the washing is conducted 3 times to 6 times, and the vacuum drying is conducted at a temperature of 60 °C to 120 °C.

18. A catalyst prepared by the method of claim 2, wherein the catalyst has interconnected macropores and mesopores, and the macropores are present on a surface of the catalyst in an open structure, the mesopores are distributed between the macropores, and acidic and basic active sites are highly dispersed in a form of an oxide inside the macropores and the mesopores, respectively.

19. A catalyst prepared by the method of claim 3, wherein the catalyst has interconnected macropores and mesopores, and the macropores are present on a surface of the catalyst in an open structure, the mesopores are distributed between the macropores, and acidic and basic active sites are highly dispersed in a form of an oxide inside the macropores and the mesopores, respectively.

20. A catalyst prepared by the method of claim 4, wherein the catalyst has interconnected macropores and mesopores, and the macropores are present on a surface of the catalyst in an open structure, the mesopores are distributed between the macropores, and acidic and basic active sites are highly dispersed in a form of an oxide inside the macropores and the mesopores, respectively.

21. A catalyst prepared by the method of claim 5, wherein the catalyst has interconnected macropores and mesopores, and the macropores are present on a surface of the catalyst in an open structure, the mesopores are distributed between the macropores, and acidic and basic active sites are highly dispersed in a form of an oxide inside the macropores and the mesopores, respectively.

22. A catalyst prepared by the method of claim 6, wherein the catalyst has interconnected macropores and mesopores, and the macropores are present on a surface of the catalyst in an open structure, the mesopores are distributed between the macropores, and acidic and basic active sites are highly dispersed in a form of an oxide inside the macropores and the mesopores, respectively.
